(19) United States
(12) Patent Application Publication
(10) Pub. No.: US 2005/0207467 A1
(43) Pub. Date: Sep. 22, 2005

(54) THREADED PIN FOR CARBON ELECTRODES, AND ELECTRODE ASSEMBLY WITH A THREADED PIN

(76) Inventor: John Montminy, Hickory, NC (US)

Correspondence Address: LERNER AND GREENBERG, PA, P O BOX 2480, HOLLYWOOD, FL, 33022-2480, US

(21) Appl. No.: 10/803,853

(22) Filed: Mar. 18, 2004

(51) Int. Cl. H05B 7/14

(52) U.S. Cl. 373/92

(57) ABSTRACT

A threaded pin is particularly suitable for connecting carbon electrodes that have at least one socket with an internal thread. The pin has a central axis running along its length, two end portions, a midplane between the two end portions, and at least one external thread. The pin is formed with a protrusion that constitutes an abutment surface extending beyond the external thread and faces towards one of the end portions.

### BACKGROUND OF THE INVENTION

Field of the Invention

The invention relates to a threaded pin, especially for connecting carbon electrodes having at least one socket with an internal thread. The pin has a central axis running along its length, two end portions, a midplane lying between the two end portions and at least one external thread. Further, the invention relates to an electrode assembly with a threaded connection, comprising an electrode and a pin.

Carbon electrodes, especially graphite electrodes, are used in the steel industry to melt metals in electrothermal furnaces such as arc furnaces. In arc furnaces, electric current is passed through the electrode forming an arc between the electrode and the metal to generate the heat necessary to melt the metal. The electric arc and the high temperatures in the furnace, which may be up to 1500° C. or even higher, cause the lower end of the electrode, which extends into the furnace into close proximity with the molten metal, to be slowly consumed. Therefore, generally a series of electrodes is joined to form an electrode column that is progressively advanced into the furnace. To compensate for the shortening of the electrode column, further electrodes are screwed onto the top end of the column.

The electrodes are joined into the columns via a pin (sometimes referred to as a nipple) connecting the ends of adjoining electrodes. The pin usually has the form of two opposed male threaded sections which may have a cylindrical or conical shape. The pin is screwed into mating threaded sockets provided on both end faces of the electrodes.

During transportation the pin is usually threaded firmly into one of the sockets of the electrode to avoid loosening of the pin due to vibrations and the like. This assembly of a pin threaded into the socket of the electrode is usually referred to as a monotroded socket. For use in a furnace, the monotroded socket is joined to another electrode by screwing the protruding portion of the pin into its exposed socket to build a column.

When a furnace is in use, currents in excess of 100,000 A as well as flexing moments or torques are exerted repeatedly on the electrode column due to the oscillation of the furnace casing. The column is also subjected to constant vibrations or impacts from the charge material, which may also place stress on the pin. The extreme mechanical, electrical and thermal stresses exerted on the pin may cause cracks in the pin and, more commonly, splitting in the upper monotroded socket. It has been found, that these cracks are also caused by different coefficients of thermal expansion (CTE) of the pin and the electrode. This is especially true, if the pin is screwed firmly into the socket for transportation. Then, the thread windings of the pin and the monotroded socket are in full contact so that different CTE growth of the pin and the socket leads to the afore-mentioned problems, particularly as the joint approaches the hot metal bath in a furnace, where the temperatures are higher and stresses, particularly in the monotroded socket, due to CTE differences become more extreme.

To avoid these undesired effects, the pin may be slightly unscrewed from the monotroded socket such that the threads are in loose contact only. In order to prevent the pin from being fully unscrewed from the monotroded socket, plastic pins are usually inserted into bores extending from the socket face of the electrode into the pin. Thus, clearances between the internal threads of the monotroded socket and the external threads of the pin are provided to allow a different CTE growth of the pin and the monotroded socket. However, the procedure to center and pin the nipple into a socket prior to shipment to the customer is cumbersome, time consuming, and highly dependent on the skill of the operator. Also, during transportation, the plastic pins are often not sufficient to restrain a nipple in a monotroded socket, and thread damage may result. This damage can leave internal debris in the monotroded socket which prevent proper tightening when the electrode is added to the furnace. Loosening may then progress until some contact surfaces become physically separated from each other, which leads to an increase in the electrical resistance of the connection. Those surfaces that are still in contact are subjected to greater current density which leads to localized overheating. As a result, the lower end of the electrode column may break off and fall into the molten steel, which interrupts the electric arc and terminates the smelting process.

Alternatively, plastic pieces may be glued on the threads of the pin and/or the monotroded socket. This process is usually referred to as “tabbing.” The pin may then be screwed firmly into the monotroded socket for transportation and it is not necessary to loosen the pin from the monotroded socket prior to connecting the pin with a further electrode. In the furnace, the plastic material on the threads melts away such that clearances are maintained between the internal threads of the monotroded socket and the external threads of the pin to allow a different CTE growth. However, it is cumbersome to mount the plastic pieces and difficult to obtain clearances of defined dimensions.

### SUMMARY OF THE INVENTION

It is accordingly an object of the invention to provide a treaded pin for carbon electrodes and an electrode assembly with a threaded pin which overcome the above-mentioned disadvantages of the heretofore-known devices and methods of this general type and which provides for a threaded pin that ensures a threaded connection that will prevent loosening and cracking.

With the foregoing and other objects in view there is provided, in accordance with the invention, a threaded pin for connecting into a socket formed with an internal thread, the pin comprising:
a pin body having a central axis, first and second end portions, a midplane defined between the end portions, and an external thread; and
the pin body having a protrusion forming an abutment surface extending radially beyond the external thread and facing towards one of the end portions.

The threaded pin is particularly suitable and it is configured to connect carbon electrodes formed with at least one socket having the internal thread.

In other words, there is provided a threaded pin having a protrusion with an abutment surface that extends radially beyond the external thread and faces towards one of the end portions. The protrusion formed on the pin provides for a defined abutment to position the pin with regard to a socket of an electrode. Hence, it is not possible to firmly screw the pin into an electrode such that the thread windings are in full contact. Moreover, the protrusion of the pin comes in contact with a corresponding face of the electrode such that open clearances are provided between the internal thread of the electrode and the external thread of the pin. This prevents the pin threads from fully engaging the socket threads during setting in the finishing department prior to shipping of a monotroded socket. These open clearances, which were previously only possible with the afore-mentioned pinning or tabbing of the pin, allow CTE growth of the pin in the monotroded socket. Consequently, the occurrence of socket splits in the threaded connection, which can lead to full length splits, body breaks, and loosening in the joint, is reduced. In addition, a monotroded socket, i.e. a pin screwed into the socket of an electrode, is still stable during transportation and handling as the forces exerted on the protrusion of the pin are sufficient to prevent loosening of the pin. Further, hoop stresses in the monotroded socket are alleviated, which further helps to minimize the formation of splits.

When an electrode is monotroded by inserting a pin prior to shipment, it is known to measure a so called “pin gauge protrusion”. This is a measure of how deeply seated the pin is in the electrode socket; that is, how far the pin protrudes outside of the socket as measured from the flat end-face with respect to a reference point on the pin using a pin gauge.

This pin gauge protrusion is, at least indirectly, an indication of how far the pin will insert into a non-monotroded socket when assembled on an arc furnace. The total distance that the pin will insert into the non-monotroded socket of an electrode on an arc furnace then depends on the monotroded socket tolerances, the tolerances of the monotroded side of the pin, the tolerances of the non-monotroded side of the pin and the non-monotroded socket tolerances.

The abutment surface on the protrusion of the pin according to the present invention ensures that the monotroded side of the pin will only insert a certain distance into a monotroded socket, and ensures that there is clearance between the pin threads and socket threads. Therefore, the pin protrusion, in theory, will only depend on the placement of the abutment surface on the pin, with the variation of this being relatively small, and the amount that the reference pin gauge will fit onto the protruding part of the pin, but not how deeply seated the monotroded pin is into the monotroded socket. Therefore, pin gauge protrusion variation can roughly be cut in half with the new design. Moreover, the variation of the distance that the non-monotroded side of the pin will insert into a non-monotroded socket on an electrode on an arc furnace can be minimized (by half), as well. The net result is that assembled furnace electrode joint variation is lower by about half.

The abutment surface of the pin may be part of a flange, which is integrally formed or separately provided on the pin.

According to a preferred embodiment of the invention, the flange may be a retaining nut having an internal thread, which is in engagement with the external thread of the pin. Hence, standard pins may be used having a retaining or a centering nut screwed onto one end portion. The retaining nut may be made from graphite or any other suitable material such as polyphenylenether (PPE), or some other polymeric material that would eventually vaporize away when used in a furnace.

If a first of the two end portions of the pin has a smaller diameter than the second of the end portions at or in the vicinity of the midplane, the abutment surface of the pin may be formed as a protruding annular surface of the second end portion, which surface faces in the direction of the first end portion. In other words, one of the two end portions of the pin may be smaller in diameter compared with the other end portion to provide for an annular abutment surface extending substantially perpendicular to the central axis of the threaded pin. In this application, the term “midplane” is defined as the region where the pin's two end portions meet, irrespective of a possible different size of the two end portions, i.e., the midplane of the threaded pin is not necessarily the geometric center with respect to the overall length or structure of the pin.

In a preferred embodiment of the invention, at least one of the end portions, preferably both end portions, comprising the thread is conical in shape to facilitate the screwing into the electrode socket and to improve the engagement. Usually thus the pin is provided with bi-conical external threads.

It further is within the invention to provide a cylindrical portion on at least one of the end portions, preferably between the midplane and the conical portion.

Preferably, the abutment surface extends substantially perpendicular and adjacent to the cylindrical portion formed by reducing the height of the thread windings of the conical external thread and/or by reducing the core diameter of the conical portion. Such pin is easier to machine as jigs and fixtures with lathe may be used.

The present invention further is directed to an electrode assembly with a threaded connection comprising an electrode made from a carbon material with a socket having an internal thread, a bottom end and a central axis running along its length, with the assembly further comprising a pin made from a carbon material and having an external thread for connecting two electrodes, two end portions and a central axis running along its length, wherein the electrode and the pin each have abutment surfaces, which, when the pin is screwed into the socket, are facing towards each other and come in contact with each other prior to one of the end portions of the pin reaching the bottom end of the corresponding socket. Again, the defined abutment of the pin and the socket prior to one end portion of the pin reaching the bottom end of the socket provides for open gaps or clearances between the internal thread of the socket and the external thread of the pin. These open clearances in turn allow for CTE growth in the monotroded socket, thereby minimizing the risk of splits and the possibility of subsequent breaks in the pin, socket, or body.

It is preferred, to make both the electrode and the pin of synthetically produced carbon or graphite. This material imparts the property of plastic deformability. Therefore, the crests of a thread winding made from synthetically produced carbon or graphite do not simply break off but may be deformed. This further minimizes the likelihood of splits in the pin or the corresponding socket of an electrode.

The abutment surface of the socket may be provided adjacent to a recessed portion of said socket. Such a recessed portion can be easily machined thus reducing the costs for production of an electrode. It is further possible to provide such a recessed portion in an electrode having a standard socket with a conical or cylindrical internal thread.

To ensure a particularly effective abutment surface on said pin, a protruding portion may be provided on one of said two end portions. This abutment surface of the pin may be formed adjacent to a substantially cylindrical portion of at least one of said two end portions.

The external thread of the socket and the internal thread of the pin usually have thread windings with a substantially uniform pitch, a root, a crest and a substantially V-shaped profile. To provide for an approximately equal share of the load transferred between the two thread windings, it is preferred that at least one of said internal and external threads is formed with a wedge ramp at said root and that the crests of at least the other of said internal and external threads abut with said wedge ramps, when said pin is screwed into said socket. In a conventional threaded connection the top thread winding usually carries the largest load on its flank. The thread winding immediately below is subjected to a smaller load and the further thread windings below have to bear yet smaller loads. As a consequence, only a few thread windings participate in the transfer of loads. These higher stresses in the first thread windings may cause splitting of the pin and/or the socket. In contrast to that, when the crests of one thread winding abuts with the wedge ramps of the other thread winding, an approximately equal share of the load is transferred by all of the thread windings. With the abutment surface being provided on the protrusion of the pin, the above-mentioned modified thread form may be used in the monotroded socket more easily, because the counter-forces ensure that proper contact between the standard threads and the wedge ramps is maintained during transportation, etc., prior to adding the monotroded electrode to an electrode on an arc furnace.

Additional information concerning the foregoing is found in the commonly assigned, copening patent application Ser. No. 10/699,134, filed Oct. 31, 2003; the entire disclosure of the copening application is herewith incorporated by reference.

Other features which are considered as characteristic for the invention are set forth in the appended claims.

Although the invention is illustrated and described herein as embodied in a threaded pin for carbon electrodes, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic longitudinal section of two electrodes joined together by a pin according to a first embodiment of the invention;

FIG. 2 is a similar longitudinal section of two electrodes joined together by a pin according to a second embodiment of the invention;

FIG. 3 is a similar longitudinal section of two electrodes joined together by a pin according to a third embodiment of the invention; and

FIG. 4 is a sectional and elevational view of the assembly according to FIG. 3 on an enlarged scale.

### DESCRIPTION OF THE PREFERRED EMBODIMENTS

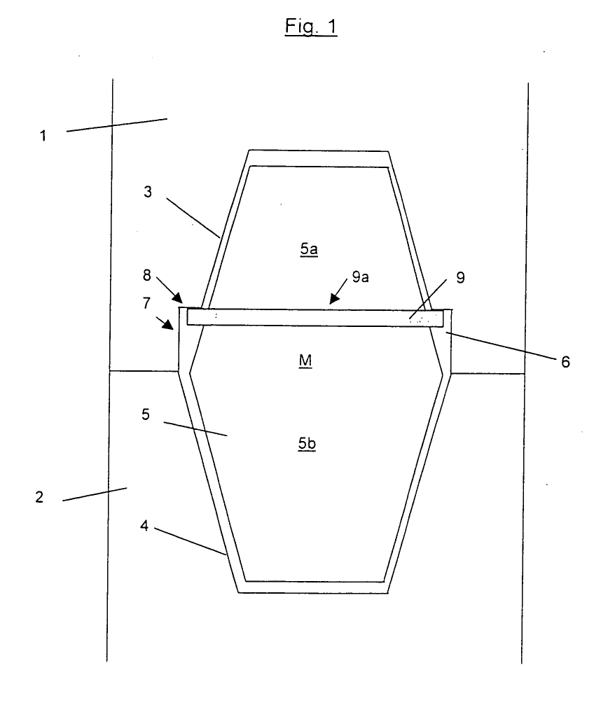

Referring now to the figures of the drawing in detail and first, particularly, to FIG. 1 thereof, there are shown two electrodes 1 and 2, each formed with a socket facing the socket of the respectively other electrode. The electrodes 1, 2 are coaxially fixed by a connecting pin, which is screwed into both sockets. The electrodes 1, 2 and the connecting pin are made from a carbon material, preferably graphite.

Referring now to FIG. 1, the lower conical socket 4 is a standard socket, whereas the upper (monotroded) socket 3 is provided with a counter-bore 6. The counter bore 6 defines a cylindrical portion 7 and an abutment surface 8, which adjoins the cylindrical portion 7 and extends substantially perpendicular to the central axis of the electrodes.

A connecting pin 5 is a standard connecting pin having two conical end portions 5a, 5b and a midplane M between the two end portions. Conical outer threads, or external threads, are provided on each of the two end portions 5a, 5b. The outer threads engage and mesh with internal threads of the sockets 3, 4. On the upper conical end portion 5a, there is provided a retaining nut 9 which is screwed on the external threads of the upper conical portion 5a. The retaining nut may be made from a carbon material, preferably graphite, or a polymeric material such as polyphenylenether (PPE). A polymeric material will eventually vaporize away in the course of the application.

The retaining nut 9 provides for an abutment surface 9a which is in contact with the abutment surface 8 of the upper socket 3. Due to the abutment of surfaces 8 and 9a, it is not possible to fully screw the pin 5 into the upper socket 3.

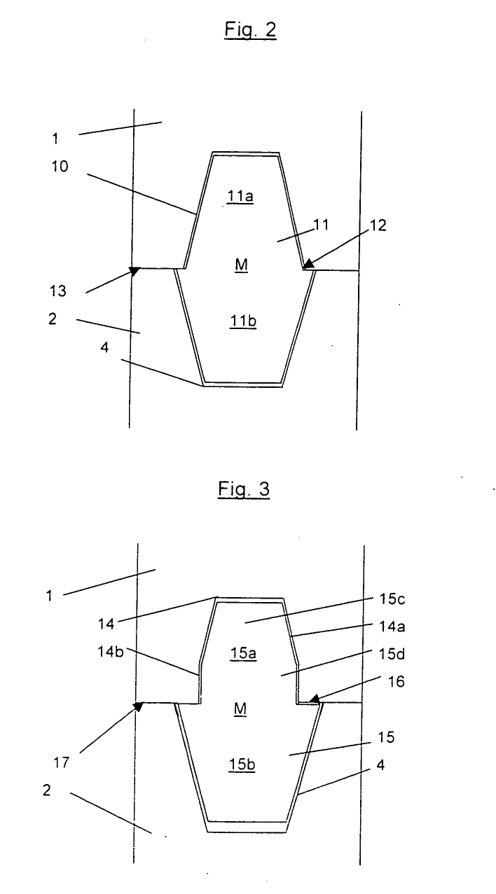

Turning now to FIG. 2, again two electrodes 1 and 2 are depicted having conical sockets 3 and 4, respectively, with internal threads. However, the diameter of the upper (monotroded) socket 3 is smaller than the diameter of the lower socket 4 in the region, where the two electrodes 1, 2 face each other. Further, a connecting pin 11 is provided having two conical end portions 11a, 11b which are screwed into the upper socket 10 and the lower socket 4, respectively. In the vicinity of the midplane M lying between the two end portions 11a, 11b of the pin, the upper end portion 11a has a smaller diameter than the lower end portion 11b. Thus, an annular protrusion 12 is defined on the lower end portion 11b of the pin facing towards the upper end portion 11a. As the upper socket 10 has a smaller diameter than the lower socket 4, an abutment surface 13 is defined on the upper electrode 1. As the pin 11 is screwed into the upper electrode 1, the abutment surface 12 of the pin comes in contact with the abutment surface 13 of the electrode 1 prior to the upper end portion 11a of the pin being fully screwed into the upper socket 10.

FIG. 3 shows two electrodes 1, 2 each having a socket 14, 4 with internal threads and a pin 15 having external threads on two end portions 15a, 15b which are threaded into the sockets 14 and 4, respectively. The upper (monotroded) socket 14 has a conical upper portion 14a and a cylindrical lower portion 14b adjacent to the end face of electrode 1. In contrast to that, the lower socket 4 is formed as a standard conical socket. Correspondingly, the lower end portion 15b of pin 15 is formed as a standard pin, whereas the upper end portion 15a comprises an upper conical portion 15c and a lower cylindrical portion 15d. As the cylindrical portion 15d of the pin has a smaller diameter than the lower end portion 15b in the vicinity of a midplane M, an annular protruding abutment surface 16 is defined on pin 15 adjacent to the cylindrical portion 15d. Further, as the cylindrical portion 14b of the upper socket has a smaller diameter than the lower socket 4 in the vicinity of the end face of electrode 2, an annular abutment surface 17 is defined on electrode 1. As can be seen from FIG. 3, abutment surfaces 16 and 17 come into contact prior to the upper end portion 15a of the pin being fully screwed into upper socket 14.

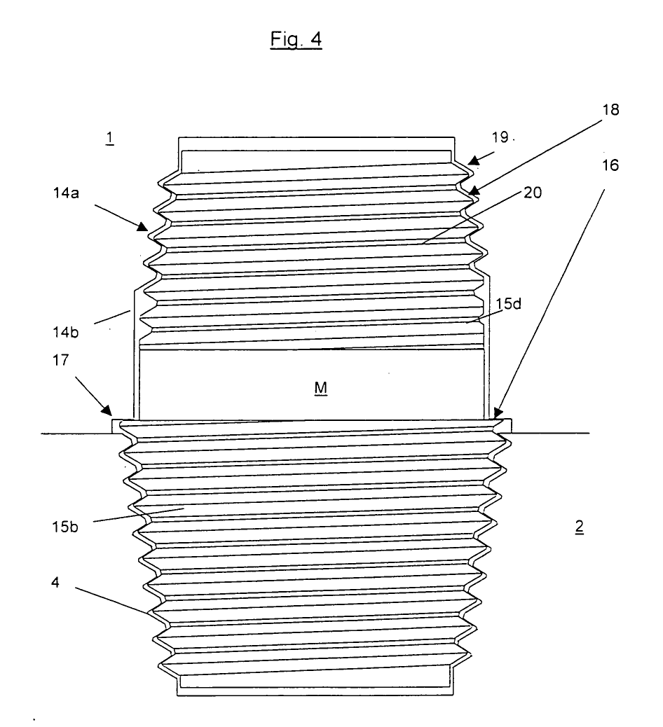

As depicted in FIG. 4, which shows a construction similar to that of FIG. 3, there are provided open clearances 18 between the internal thread 19 of the socket 14 and the external thread 20 of the pin 15, when the abutment surfaces 16 and 17 come into contact. This allows CTE growth of the pin 15 within the socket 14 without causing further stresses in the pin or the socket. Consequently, the likelihood of shear splits or breaks is minimized.

In the embodiment depicted in FIG. 4, the cylindrical portion 15d of pin 15 is formed by reducing the height of the thread windings of the conical external thread 20 and by reducing the diameter of the core of the upper end portion 15a of pin 15. This provides for the flanged abutment surface 16 of pin 15 lying in the vicinity of midplane M.

1. A threaded pin for connecting into a socket formed with an internal thread, the pin comprising;
a pin body having a central axis, first and second end portions, a midplane defined between said end portions, and an external thread; and
said pin body having a protrusion forming an abutment surface extending radially beyond said external thread and facing towards one of said end portions.

2. The threaded pin according to claim 1, wherein said pin body is formed to connect carbon electrodes formed with at least one socket having the internal thread.

3. The threaded pin according to claim 1, wherein said abutment surface forms part of a flange integrally formed on said pin body.

4. The threaded pin according to claim 1, which comprises a retaining nut formed with an internal thread meshing with said external thread of said pin body, and wherein said abutment surface is formed on said retaining nut.

5. The threaded pin according to claim 4, wherein said retaining nut is formed of graphite.

6. The threaded pin according to claim 4, wherein said retaining nut is formed of a polymeric material.

7. The threaded pin according to claim 6, wherein said polymeric material is polyphenylenether.

8. The threaded pin according to claim 1, wherein at or in a vicinity of said midplane, said first end portion has a smaller diameter than said second end portion, said abutment surface is formed as a protruding annular surface of said second end portion, and said abutment surface faces in a direction of said first end portion.

9. The threaded pin according to claim 1, wherein at least one of said first and second end portions has a conical portion formed with said external thread.

10. The threaded pin according to claim 9, wherein at least one of said first and second end portions has a cylindrical portion formed between said midplane and said conical portion.

11. The threaded pin according to claim 10, wherein said abutment surface extends substantially perpendicularly and adjacent to said cylindrical portion.

12. The threaded pin according to claim 10, wherein said thread is formed with windings on said conical portion, and said windings have a reduced height in a portion thereof, defining said cylindrical portion.

13. The threaded pin according to claim 10, wherein said cylindrical portion is formed as a reduction in a diameter of said conical portion.

14. An electrode assembly, comprising:
two electrodes of carbon material each formed with a respective socket having an internal thread and a bottom end;
a pin of carbon material formed with an external thread and two end portions for connecting said two electrodes to form an electrode column;
at least one of said electrodes and said pin each having an abutment surface configured to come into contact with the respectively other said abutment surface when said pin is screwed into said socket, before said end portion of said pin reaches said bottom end of said socket, said abutment surface of said pin being defined on a protrusion formed on one of said two end portions, and said protrusion projecting radially beyond said external thread.

15. The electrode assembly according to claim 18, wherein said electrode is one of two electrodes each formed with a respective socket, and said pin is formed with two end portions for connecting said two electrodes to form an electrode column.

16-17. (canceled)

18. An electrode assembly, comprising:
an electrode of carbon material formed with a socket having an internal thread and a bottom end;
a pin of carbon material formed with an external thread for connecting to said electrode and an end portion;
said electrode and said pin each having an abutment surface configured to come into contact with the respectively other said abutment surface when said pin is screwed into said socket, before said end portion of said pin reaches said bottom end of said socket, said abutment surface of said socket adjoining a recessed portion of said socket, and said abutment surface of said pin being defined on a protrusion formed on said end portion, and said protrusion projecting radially beyond said external thread.

19. The electrode assembly according to claim 14, wherein said end portion of said pin is formed with a substantially cylindrical portion adjacent said abutment surface of said pin.

20. The electrode assembly according to claim 18, wherein said external thread of said pin and said internal thread of said socket have thread windings with a substantially uniform lead, a root, a crest, and a substantially V-shaped profile, wherein at least one of said internal and external threads is formed with a wedge ramp at said root, and wherein said crests of a respectively other thread abut against said wedge ramps when said pin is screwed into said socket.
